(19) United States
(12) Patent Application Publication
(10) Pub. No.: US 2015/0174620 A1
(43) Pub. Date: Jun. 25, 2015

(54) Surface Cleaning Apparatus with Mist Spray or Water Spray Arrangement

(71) Applicant: Jinran Liang, Zhongshan (CN)

(72) Inventor: Jinran Liang, Zhongshan (CN)

(21) Appl. No.: 14/379,084

(22) PCT Filed: Nov. 27, 2013
(86) PCT No.: PCT/CN13/87971

§ 371 Date: Aug. 15, 2014

(30) Foreign Application Priority Data
Jun. 3, 2013 (CN) 201310216967.9

(51) Int. Cl. B08B 3/02

(52) U.S. Cl. CPC B08B 3/02

(57) ABSTRACT

A surface cleaning apparatus with mist spray or water spray arrangement, characterized in that, the apparatus comprises: a mist spray or liquid spray arrangement for spraying cleaning solution in liquid or mist form onto a surface of an object for cleaning; a suction mouthpiece arranged for removing the cleaning solution and environmental air from the surface of the object for cleaning in a timely manner; a first tank unit having a tank cavity for receiving the cleaning solution; and a suction unit for generating a negative pressure for providing a suction force such that the cleaning solution is guided into the tank unit while the environmental air is discharged. The apparatus of the present invention has both suction function for cleaning and mist spray or water spray function at the same time, additional separate mist spray or water spray device is not required and operational convenience is provided.

### CROSS REFERENCE OF RELATED APPLICATION

This is a national phase national application of an international patent application number PCT/CN2013/087971 with a filing date of Nov. 27, 2013, which claimed priority of a foreign application number 201310216967.9 with a filing date of Jun. 3, 2013 in China. The contents of these specifications, including any intervening amendments thereto, are incorporated herein by reference.

### BACKGROUND OF THE PRESENT INVENTION

1. Field of Invention

The present invention relates to a surface cleaning device with mist spray or liquid spray arrangement, and more particularly relates to a surface cleaning device which is capable of producing a mist spray or a liquid spray for cleaning a surface of a hard cleaning subject.

2. Description of Related Arts

In general, when cleaning a surface of an object such as the surface of a glass object, cleaning solution will be sprayed onto the surface of the glass object and a cleaning apparatus will be used onto the surface of the glass object for cleaning. In order to remove the fluid on a surface of a hard object such as a surface of glass object in a timely manner, a Chinese patent application publication number CN101909499B discloses a portable vacuum device for hard surface.

However, existing surface cleaning devices only include a suction function for cleaning purpose but fail to provide a mist spray or a liquid spray function for cleaning When cleaning the surface of an object, a separate mist spray or liquid spray device has to be used for spraying the cleaning solution onto the surface of the object and then a surface cleaning apparatus is used to perform the suction action, which is very inconvenience during operation. In addition, since the user needs to buy additional separate mist spray or liquid spray device, additional cost for the user is required.

### SUMMARY OF THE PRESENT INVENTION

An object of the present invention is to provide a surface cleaning apparatus with mist spray or water spray arrangement which is capable of providing suction function for cleaning as well as mist spray or water spray function at the same time such that additional separate mist spray or water spray device is not required and operational convenience is provided.

Accordingly, the present invention provides a surface cleaning apparatus with mist spray or water spray arrangement, characterized in that, the surface cleaning apparatus with mist spray or water spray arrangement comprises:

a mist spray or liquid spray arrangement adapted for spraying cleaning solution in liquid or mist form onto a surface of an object for cleaning;

a suction mouthpiece arranged for removing the cleaning solution and environmental air from the surface of the object for cleaning in a timely manner;

a first tank unit having a tank cavity connected to the suction mouthpiece through a tank connecting pipe, arranged for receiving the cleaning solution from the suction mouthpiece; and

a suction unit connected to the suction mouthpiece through a suction unit connecting pipe, arranged for generating a negative pressure for providing a suction force such that the cleaning solution is guided to enter into the tank unit while the environmental air is discharged.

According to the present invention, the surface cleaning apparatus with mist spray or water spray arrangement has the following advantageous features: 1. the apparatus is equipped with suction function for cleaning while having mist spray or water spray function at the same time, therefore additional separate mist spray or water spray device is not required and operational convenience is provided. 2. There is no need to buy additional separate mist spray or liquid spray device and the user can save the cost for spraying device.

According to the present invention, the following modifications can be employed:

The apparatus further comprises: a first connecting pipe, which is a suction piping arrangement, connected between the suction mouthpiece and the first tank unit, arranged for transporting the cleaning solution and the environmental air from the suction mouthpiece to the first tank unit; and a second connecting pipe, which is a negative pressure piping arrangement, connected between the suction unit and the first tank unit and communicated with the first connecting pipe through the tank cavity inside the first tank unit; wherein the suction mouthpiece, the first connecting pipe, the first tank unit, the second connecting pipe and the suction unit are sequentially aligned in a top-down direction; wherein the cleaning solution and the environmental air being drawn from the suction mouthpiece are guided to flow into the first tank unit from the same route which runs from a top-down direction, and then the cleaning solution is retained inside the first tank after being drawn from the suction mouthpiece while the environmental air being drawn from the suction mouthpiece is guided to flow continuously in the top-down direction in which the environmental air passes through the second connecting pipe and is exited from the suction unit. According to the preferred embodiment of the present invention, the suction mouthpiece, the first connecting pipe, the first tank unit, the second connecting pipe and the suction unit are sequentially aligned in a top-down direction such that the cleaning solution and the environmental air being drawn from the suction mouthpiece are guided to flow into the first tank unit in the top-down direction by the same route, therefore the suction force for cleaning is enhanced and the suction action for the cleaning solution on the surface of the object for cleaning for guiding the cleaning solution to flow to the first tank unit is further accelerated. In addition, the sequential positioning of the suction mouthpiece, the first connecting pipe, the first tank unit, the second connecting pipe and the suction unit in a top-down direction offers a simple structural construction while providing an enhanced and smooth flowing route.

The first tank unit has a bottom portion and comprises an exhaust pipe in the bottom portion of the first tank unit extending upwardly from the bottom portion towards the inside of the first tank unit, and the exhaust pipe defines a bottom end connecting to the second connecting pipe and a top end connecting to the tank cavity of the first tank unit. This offers a simple structural construction, ease of separation of the cleaning solution and the environmental air being drawn into the first tank unit while ensuring that the first tank unit can contain a certain amount of solution.

The first tank unit has a top portion and comprises a water inlet pipe at the top portion of the first tank unit, the water inlet pipe defines a top end extending outside the first tank unit and connecting to the first connecting pipe and a bottom end downwardly extending towards the first tank unit and connecting to the tank cavity of the first tank unit. This offers a simple structural construction while ensuring that the liquid inside the first tank unit will not backflow when cleaning the surface of the object for cleaning along a horizontal direction by the surface cleaning apparatus of the present invention.

The exhaust pipe and the water inlet pipe are staggered longitudinally at a distance. This offers a simple structural construction while allowing sufficient separation of the cleaning solution and the environmental air being drawn after entering into the first tank.

The bottom end of the water inlet pipe is a close end and is indented at a side to define an indented side, wherein an indented side portion is defined at the indented side of the water inlet pipe and a bottom end opening is provided at a side of the bottom end opposite to the indented side portion which is open to the tank cavity; while the top end of the exhaust pipe is a close end and a portion of the top end of the exhaust pipe is extended towards the indented side portion to biased against the indented side portion to define a top side, the top end of the exhaust pipe has a top end opening provided at a side of the top end of the exhaust pipe which is opposite to the side at which the exhaust pipe is biased against the indented side portion and the top end opening of the exhaust pipe is open to the tank cavity. This offers a compact and simple structural construction. Because the diameter of the water inlet pipe is relatively smaller while the outer diameter of the cavity of the first tank unit is much greater than the diameter of the water inlet pipe, the flow rate of the liquid and the environmental air being drawn into the relatively big cavity of the first tank unit through the inlet pipe with relatively small pipe diameter will be decreased and allow sufficient separation of the liquid and the environmental air after entering into the first tank unit; meanwhile, the opening of the water inlet pipe and the opening of the exhaust pipe are positioned at two opposite sides, which further facilitate the separation of the liquid and the environmental air after entering into the first tank unit; in addition, the construction of the water inlet pipe and the exhaust pipe can optimize the capacity of the first tank unit.

The bottom portion of the first tank unit 3 comprises a first slanted bottom member on a right side of the first tank unit, upwardly extended and inclined from a left side of the bottom portion of the first tank unit to the right side of the first tank unit; and a second slanted bottom member upwardly extended and inclined continuously from the first slanted bottom member to the right side of the first tank unit to connected to a side wall of the first slanted bottom member, wherein the exhaust pipe is provided on the second slanted bottom member. This offers a simple structural construction while creating a space for positioning the second connecting pipe at a position corresponding to the position of the first slanted bottom member and the second slanted bottom member inside the main body.

The surface cleaning apparatus with mist spray or water spray arrangement comprises: a nozzle member; a press-type one-way control valve, which comprises a valve body having a valve inlet and a valve outlet; a valve core provided inside the valve body; a resilient member acting on the valve core inside the valve body for positioning; and a valve core pushrod operatively connected to the valve core defining a first end connecting to the valve core and a second end opposite to the first end extending from the valve body to outside and defining an extending end; a second tank unit having a second tank cavity arranged for receiving the cleaning solution; a water inlet tube connected between the second tank unit and the valve inlet of the valve body; and a spray conduit connected between the nozzle member and the valve outlet of the valve body, wherein when the extending end of the valve core pushrod is pressed, the valve core is driven to withstand an action of the resilient member and to move along the valve body such that high pressure is generated inside the valve body, then the cleaning solution being drawn into the valve body is guided to pass through the valve outlet of the valve body and the spray conduit to spray outside from the nozzle member; wherein when the extending end of the valve core pushrod is released, the valve core returns to its normal position through the action of the resilient member such that negative pressure is formed inside the valve body, then the cleaning solution in the second tank unit is drawn into the valve body through the water inlet tube. This offers a simple structural construction for spraying the liquid for cleaning

The surface cleaning apparatus with mist spray or water spray arrangement further comprises: a main body defining a top portion; and a connecting member provided at the top portion of the main body having an indented connecting cavity in the middle portion of the connecting member; wherein the suction mouthpiece is detachably connected to the connecting member; wherein the first connecting pipe is provided inside the main body and is positioned between the connecting member and the indented connecting cavity; wherein the first tank unit is detachably mounted inside the indented connecting cavity; wherein the nozzle member is positioned between the suction mouthpiece and the first tank unit, and is exposed from the main body; wherein second tank unit is provided inside the main body at a side opposite to the side at which the nozzle member is positioned, and is positioned on top of the first tank unit; wherein the main body further comprises an index window at a position corresponding to the second tank unit and a portion of side wall of the second tank unit is exposed through the index window for viewing a water level of the cleaning solution; wherein the press-type one-way control valve is provided inside the main body and is positioned below the second tank unit; wherein the extending end of the valve core pushrod is extended outside from the main body; wherein the second connecting pipe and the suction unit are provided inside the main body and are sequentially positioned below the indented connecting cavity; wherein the main body has a gas outlet open at a position corresponding to a position of a side wall of the suction unit and the environmental air which is drawn into the main body is exhausted from the suction unit through the gas outlet. This offers a simple structural construction and suitable organization.

The main body comprises: a handle at one side opposite to the side of the indented connecting cavity; and a plug portion at a bottom of the main body at the same side at which the handle is positioned adapted for inserting an elongated extension handle member, wherein the extending end of the valve core pushrod is positioned at the same side at which the handle is positioned. This offers a simple structural construction, through the extending end of the valve core pushrod, the solution for cleaning can be sprayed easily. Then, through holding the handle of the surface cleaning apparatus or the elongated extension handle member, the cleaning process for the surface of the object for cleaning can be carried out, which is easy and convenience to use.

### BRIEF DESCRIPTION OF THE DRAWINGS

FIG. 1 is a first structural illustration according to the preferred embodiment of the present invention.

FIG. 2 is a second structural illustration according to the preferred embodiment of the present invention.

FIG. 3 is an exploded view of the structural illustration according to the preferred embodiment of the present invention.

FIG. 4 is a sectional view of the structural illustration according to the preferred embodiment of the present invention.

FIG. 5 is a sectional view of the structural illustration of the tank unit according to the preferred embodiment of the present invention.

### DETAILED DESCRIPTION OF THE PREFERRED EMBODIMENT

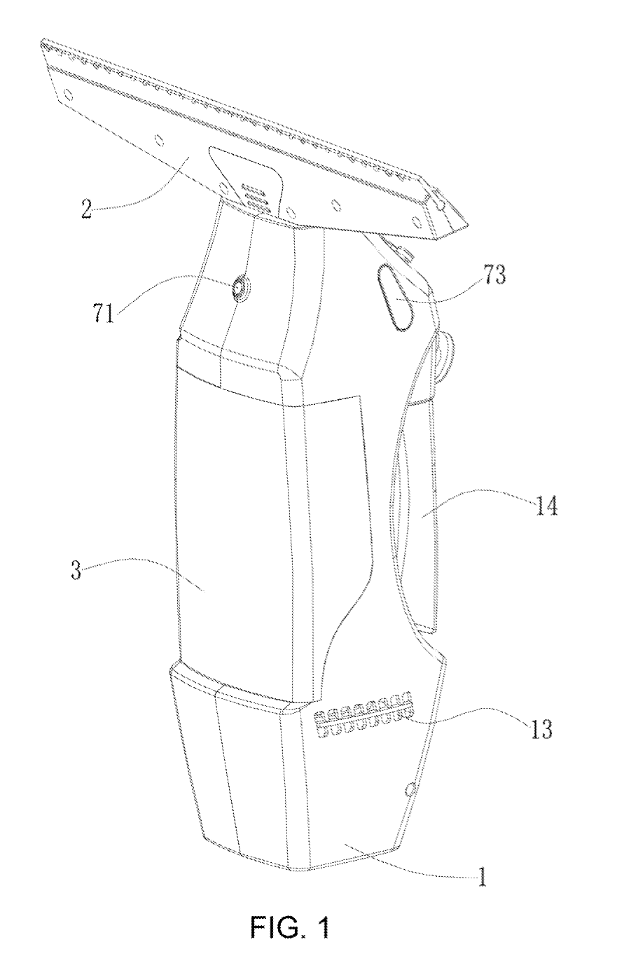

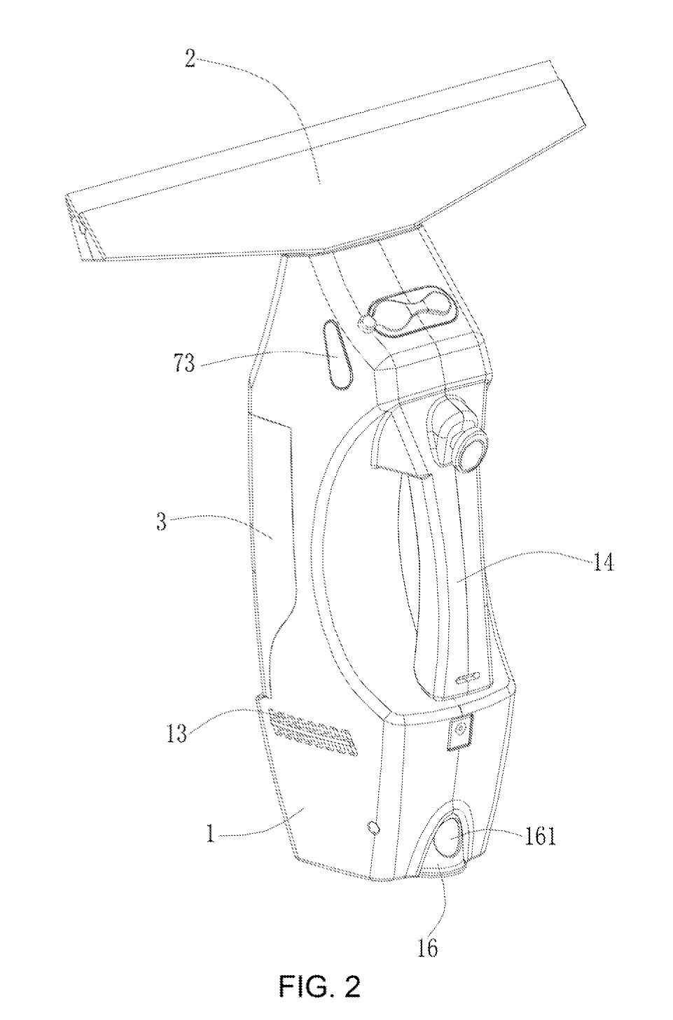

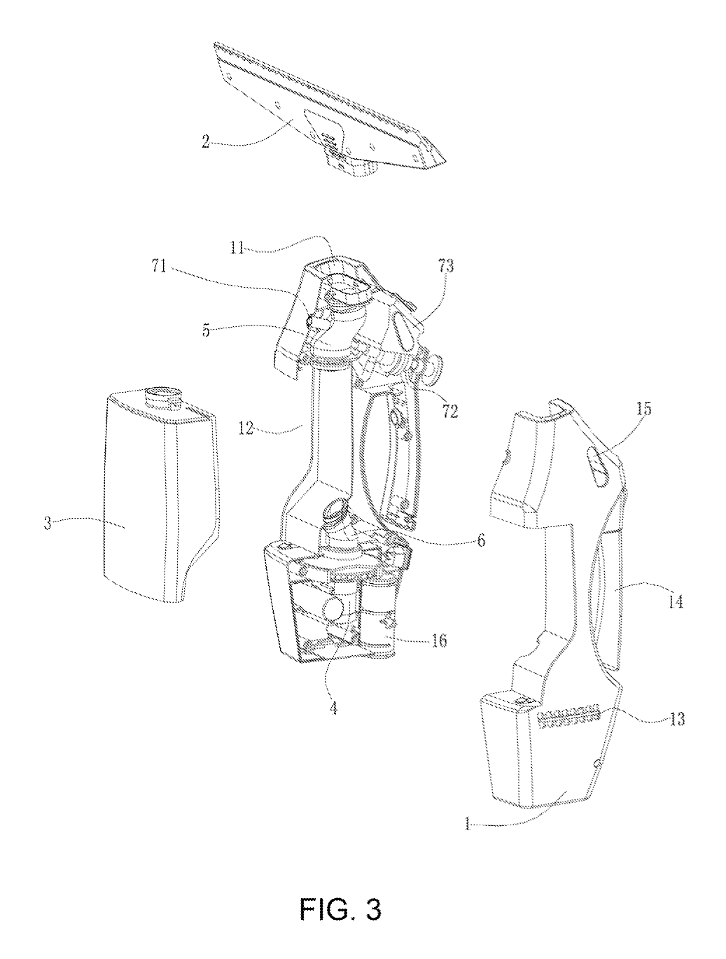

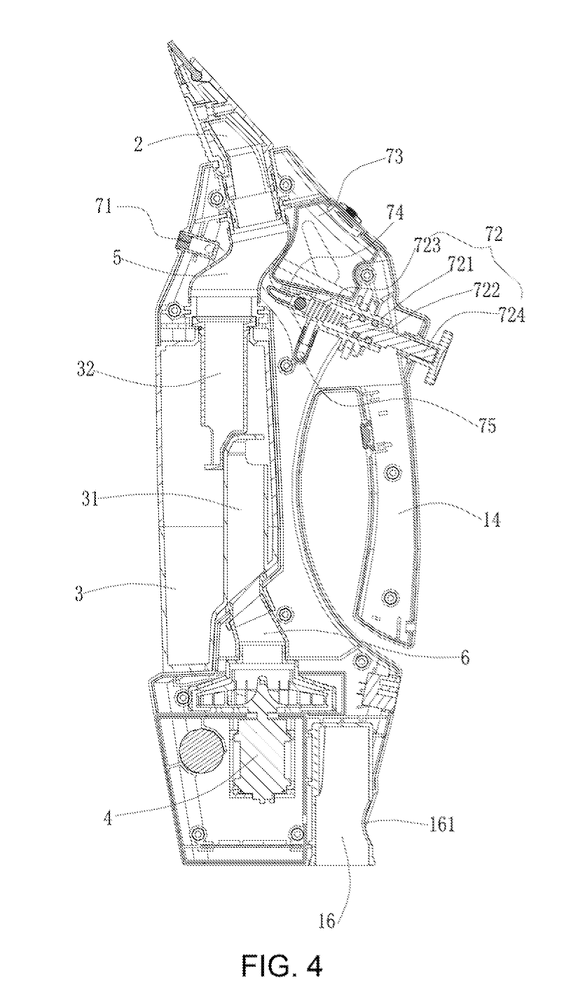

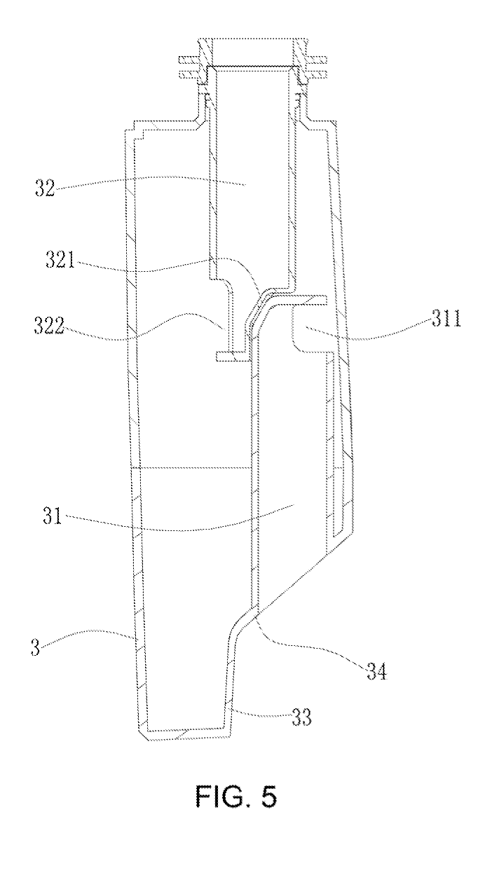

Referring FIGS. 1 to 5 of the drawings, a surface cleaning apparatus with mist spray or liquid spray arrangement according to a preferred embodiment of the present invention comprises a mist spray or a liquid spray arrangement, a suction mouthpiece 2, a first tank unit 3 and a suction unit 4.

The mist spray or liquid spray arrangement is arranged for spraying cleaning solution in liquid or mist form onto a surface of an object for cleaning

The suction mouthpiece 2 is arranged for removing the cleaning solution and environmental air from the surface of the object for cleaning in a timely manner.

The first tank unit 3 has a tank cavity and is connected to the suction mouthpiece 2 for receiving the cleaning solution from the suction mouthpiece.

The suction unit 4 is connected to the suction mouthpiece, arranged for generating a negative pressure for providing a suction force such that the cleaning solution is guided to enter into the first tank unit while the environmental air is discharged.

The surface cleaning apparatus with mist spray or water spray arrangement further comprises a first connecting pipe 5 and a second connecting pipe 6. The first connecting pipe 5, which is a suction piping arrangement, is connected between the suction mouthpiece 2 and the first tank unit 3 and is arranged for transporting the cleaning solution and the environmental air from the suction mouthpiece to the first tank unit 3; the second connecting pipe 6, which is a negative pressure piping arrangement, is connected between the suction unit 4 and the first tank unit 3 and is communicated with the first connecting pipe 5 through the tank cavity inside the first tank unit 3; the suction mouthpiece 2, the first connecting pipe 5, the first tank unit 3, the second connecting pipe 6 and the suction unit 4 is sequentially aligned in a top-down direction; the solution drawn from the suction mouthpiece 2 and the environmental air are guided into the first tank unit 3 through the first connecting pipe 5 from the same route passing from a top side to a bottom side, and after the suction mouthpiece 2 draws the solution into the first tank unit 3, the solution is received inside the first tank unit 3 while after the suction mouthpiece 2 draws the environmental air into the first tank unit 3, the environmental air passes through from the top side to the bottom side and is discharged from the suction unit 4 through the second connecting pipe 6.

Furthermore, the first tank unit 3 has a bottom portion and an exhaust pipe 31 is provided on the bottom portion of the first tank unit 3 extending from the bottom portion towards the inside of the first tank unit 3 upwardly, wherein the exhaust pipe 31 defines a bottom end connecting to the second connecting pipe 6 and a top end connecting to the tank cavity of the first tank unit 3.

Furthermore, the first tank unit 3 has a top portion and a water inlet pipe 32 is provided at the top portion of the first tank unit 3. The water inlet pipe 32 defines a top end extending outside the first tank unit 3 and connecting to the first connecting pipe 5, and a bottom end extending inside the first tank unit 3 downwardly and connecting to the tank cavity of the first tank unit 3.

Furthermore, the exhaust pipe 31 and the water inlet pipe 32 is longitudinally staggered to define a distance between the exhaust pipe 31 and the water inlet pipe 32 longitudinally.

Furthermore, the bottom end of the water inlet pipe 32 is a sealed end and is indented to define an indented side and an indented side portion is defined on the indented side of the water inlet pipe 32. An bottom end opening 322 is provided at a side of the bottom end opposite to the indented side portion and is open to the tank cavity; the top end of the exhaust pipe 31 is a sealed end and a portion of the top end of the exhaust pipe 31 is extended towards the indented side portion and biased against the indented side portion to define a top side. A top end opening 311 is provided at a side of the top end opposite to the side at which the exhaust pipe 31 is biased against the indented side portion and the top end opening 311 is open to the tank cavity.

Furthermore, the bottom end opening 322 of the bottom end of the water inlet pipe 32 and the top end opening 311 of the top end of the exhaust pipe 31 are positioned at two opposite sides. In particular, the bottom end opening 322 of the bottom end of the water inlet pipe 32 is positioned at the left side of the water inlet pipe 32 while the top end opening 311 of the top end of the exhaust pipe 31 is positioned at the right side of the the exhaust pipe 31 close to an inner wall of the first tank unit 3.

Furthermore, the bottom portion of the first tank unit 3 comprises a first slanted bottom member 33 on the right side of the first tank unit 3 extending from the left side upwardly and inclinedly to the right side of the first tank unit 3, and a second slanted bottom member 33 connected to the first slanted bottom member 33 continuously extending from the first slanted bottom member 33 upwardly and inclinely to the right side of the first tank unit 3. The exhaust pipe 31 is provided on the second slanted bottom member 33.

Furthermore, the mist spray or liquid spray arrangement comprises a nozzle member 71, a press-type one-way control valve 72, a second tank unit 73, a water inlet tube 74 and a spray conduit 75.

In particular, the press-type one-way control valve 72 comprises a valve body 721 having a valve inlet and a valve outlet, a valve core 722 provided inside the valve body, a resilient member 723 for positioning function acting on the valve core provided inside the valve body, a valve core pushrod 724 operatively connected to the valve core defining a first end and a second end opposite to the first end in which the first end is connected to the valve core 722 and the second end is extended from the valve body to outside. According to this embodiment, the valve core pushrod 724 and the valve core 722 are integrally connected. The second tank unit 73 has a second tank cavity arranged for receiving cleaning solution. The water inlet tube 74 is connected between the second tank unit 73 and the valve inlet of the valve body 721. The spray conduit 75 is connected between the nozzle member 71 and the valve outlet of the valve body 721. The valve core pushrod 724 defines an extending end at the second end of the valve core pushrod and the pressing of the extending end of the valve core pushrod 724 will drive the valve core 722 to withstand the action of the resilient member 723 and to move along the valve body 721 such that high pressure is formed inside the valve body 721, the cleaning solution entered into the valve body 721 will then pass through the valve outlet of the valve body 721 and the spray conduit 75 and spray outside from the nozzle member 71. When the extending end of the valve core pushrod 724 is released, the valve core 722 returns to its normal position under the action of the resilient member 723 such that negative pressure is formed inside the valve body 721, then the cleaning solution in the second tank unit 73 is drawn into the valve body 721 through the water inlet tube 74.

Furthermore, according to the preferred embodiment of the present invention, the surface cleaning apparatus with mist spray or water spray arrangement further comprises a main body 1 defining a top portion, and a connecting member 11 at the top portion of the main body 1 having an indented connecting cavity 12 in the middle portion of the connecting member 11. The suction mouthpiece 2 is detachably connected to the connecting member 11. The first connecting pipe 5 is provided inside the main body and is positioned between the connecting member 11 and the indented connecting cavity 12. The first tank unit 3 is detachably mounted inside the indented connecting cavity 12. The nozzle member 71 is positioned between the suction mouthpiece 2 and the first tank unit 3 and is exposed from the main body 1. The second tank unit 73 is provided inside the main body 1 at a side opposite to the side at which the nozzle member 71 is positioned and is positioned on top of the first tank unit 3. The main body 1 further comprises an index window 15 for viewing a water level of the cleaning solution at a position corresponding to the second tank unit 73 and a portion of side wall of the second tank unit 73 is exposed therefrom. The press-type one-way control valve 72 is provided in the main body and is positioned below the second tank unit 73. The extending end of the valve core pushrod 724 is extended outside from the main body 1. The second connecting pipe 6 and the suction unit 4 are provided inside the main body 1 and is sequentially positioned below the indented connecting cavity 12. The main body 1 has a gas outlet 13 open at a position corresponding to a position of a side wall of the suction unit 4. The environmental air which is drawn into the main body is exhausted from the suction unit 4 through the gas outlet 13.

Furthermore, the main body 1 comprises a handle 14 at a side opposite to the side of the indented connecting cavity 12 and a plug portion 16 at a bottom of the main body at the same side as the side at which the handle 14 is positioned arranged for inserting an elongated extension handle member. The plug portion 16 has a locking hole 161 open at a side wall of the plug portion 16 arranged for locking a positioning member (not shown in the drawings) of the elongated extension handle member into position. The extending end of the valve core pushrod 724 is positioned at the same side at which the handle 14 is positioned.

One skilled in the art will understand that the embodiment of the present invention as shown in the drawings and described above is exemplary only and not intended to be limiting. It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A surface cleaning apparatus with mist spray or water spray arrangement, characterized in that, said apparatus comprises:
a mist or liquid spray arrangement arranged for spraying cleaning solution in liquid or mist form onto a surface of an object for cleaning;
a suction mouthpiece arranged for removing the cleaning solution and environmental air from the surface of the object for cleaning in a timely manner;
a first tank unit having a tank cavity connected to said suction mouthpiece through a piping arrangement of said suction mouthpiece, arranged for receiving the cleaning solution being drawn from said suction mouthpiece; and
a suction unit connected to the piping arrangement of said suction mouthpiece, arranged for generating a negative pressure for forming a suction force such that the cleaning solution being drawn is guided to enter into said tank unit while the environmental air is discharged.

2. The surface cleaning apparatus with mist spray or water spray arrangement according to claim 1, characterized in that, said apparatus further comprises:
a first connecting pipe connected between said suction mouthpiece and said first tank unit, arranged for transporting the cleaning solution and the environmental air from said suction mouthpiece to said first tank unit; and
a second connecting pipe connected between said suction unit and said first tank unit and communicated with said first connecting pipe through said tank cavity inside said first tank unit;
wherein said suction mouthpiece, said first connecting pipe, said first tank unit, said second connecting pipe and said suction unit are sequentially aligned in a top-down direction; wherein the cleaning solution and the environmental air being drawn from said suction mouthpiece are guided to flow into said first tank unit from the same route which runs from a top-down direction, and then the cleaning solution is retained inside said first tank after being drawn from said suction mouthpiece while the environmental air being drawn from said suction mouthpiece is guided to flow continuously in the top-down direction in which the environmental air passes through said second connecting pipe and is exited from said suction unit.

3. The surface cleaning apparatus with mist spray or water spray arrangement according to claim 2, characterized in that, said first tank unit has a bottom portion and comprises an exhaust pipe in said bottom portion of said first tank unit extending upwardly from said bottom portion towards the inside of said first tank unit, and said exhaust pipe defines a bottom end connecting to said second connecting pipe and a top end connecting to said tank cavity of said first tank unit.

4. The surface cleaning apparatus with mist spray or water spray arrangement according to claim 3, characterized in that, said first tank unit has a top portion and comprises a water inlet pipe at said top portion of said first tank unit, said water inlet pipe defines a top end extending outside said first tank unit and connecting to said first connecting pipe and a bottom end downwardly extending towards said first tank unit and connecting to said tank cavity of said first tank unit.

5. The surface cleaning apparatus with mist spray or water spray arrangement according to claim 4, characterized in that, said exhaust pipe and said water inlet pipe are staggered longitudinally to define a predetermined stagger distance between said exhaust pipe and said water inlet pipe.

6. The surface cleaning apparatus with mist spray or water spray arrangement according to claim 5, characterized in that, said bottom end of said water inlet pipe is a close end and is indented at a side to define an indented side, wherein an indented side portion is defined at said indented side of said water inlet pipe and a bottom end opening is provided at a side of said bottom end opposite to said indented side portion which is open to said tank cavity; while said top end of said exhaust pipe is a close end and a portion of said top end of said exhaust pipe is extended towards said indented side portion to biased against said indented side portion to define a top side, said top end of said exhaust pipe has a top end opening provided at a side of said top end of said exhaust pipe which is opposite to the side at which said exhaust pipe is biased against said indented side portion and said top end opening of said exhaust pipe is open to said tank cavity.

7. The surface cleaning apparatus with mist spray or water spray arrangement according to claim 3, characterized in that, said bottom portion of said first tank unit 3 comprises a first slanted bottom member on a right side of said first tank unit, upwardly and inclinedly extended from a left side of said bottom portion of said first tank unit to the right side of said first tank unit; and a second slanted bottom member upwardly and inclinely extended continuously from said first slanted bottom member to said right side of said first tank unit to connected to a side wall of said first slanted bottom member, wherein said exhaust pipe is provided on said second slanted bottom member.

8. The surface cleaning apparatus with mist spray or water spray arrangement according to claim 7, characterized in that, said apparatus comprises:
a nozzle member;
a press-type one-way control valve, which comprises a valve body having a valve inlet and a valve outlet; a valve core provided inside said valve body; a resilient member acting on said valve core inside said valve body for positioning; and a valve core pushrod operatively connected to said valve core defining a first end connecting to said valve core and a second end opposite to said first end extending from said valve body to outside and defining an extending end;
a second tank unit having a second tank cavity arranged for receiving the cleaning solution;
a water inlet tube connected between said second tank unit and said valve inlet of said valve body; and
a spray conduit connected between said nozzle member and said valve outlet of said valve body,
wherein when said extending end of said valve core pushrod is pressed, the valve core is driven to withstand an action of said resilient member and to move along said valve body such that high pressure is generated inside said valve body, then the cleaning solution being drawn into said valve body is guided to pass through said valve outlet of said valve body and said spray conduit to spray outside from said nozzle member; wherein when said extending end of said valve core pushrod is released, said valve core returns to its normal position through the action of said resilient member such that negative pressure is formed inside said valve body, then the cleaning solution in said second tank unit is drawn into said valve body through said water inlet tube.

9. The surface cleaning apparatus with mist spray or water spray arrangement according to claim 8, characterized in that, said apparatus further comprises:
a main body defining a top portion; and a connecting member provided at said top portion of said main body having an indented connecting cavity in the middle portion of said connecting member;
wherein said suction mouthpiece is detachably connected to said connecting member; wherein said first connecting pipe is provided inside said main body and is positioned between said connecting member and said indented connecting cavity; wherein said first tank unit is detachably mounted inside said indented connecting cavity; wherein said nozzle member is positioned between said suction mouthpiece and said first tank unit, and is exposed from said main body; wherein second tank unit is provided inside said main body at a side opposite to the side at which said nozzle member is positioned, and is positioned on top of said first tank unit; wherein said main body further comprises an index window at a position corresponding to said second tank unit and a portion of side wall of said second tank unit is exposed through said index window for viewing a water level of the cleaning solution; wherein said press-type one-way control valve is provided inside said main body and is positioned below said second tank unit; wherein said extending end of said valve core pushrod is extended outside from said main body; wherein said second connecting pipe and said suction unit are provided inside said main body and are sequentially positioned below said indented connecting cavity; wherein said main body has a gas outlet open at a position corresponding to a position of a side wall of said suction unit and the environmental air which is drawn into said main body is exhausted from said suction unit through said gas outlet.

10. The surface cleaning apparatus with mist spray or water spray arrangement according to claim 9, characterized in that, said main body comprises:
a handle at one side opposite to the side of said indented connecting cavity; and a plug portion at a bottom of said main body at the same side at which said handle is positioned adapted for inserting an elongated extension handle member, wherein said extending end of said valve core pushrod is positioned at the same side at which said handle is positioned.

11. The surface cleaning apparatus with mist spray or water spray arrangement according to claim 1, characterized in that, said apparatus comprises:
a nozzle member;
a press-type one-way control valve, which comprises a valve body having a valve inlet and a valve outlet; a valve core provided inside said valve body; a resilient member acting on said valve core inside said valve body for positioning; and a valve core pushrod operatively connected to said valve core defining a first end connecting to said valve core and a second end opposite to said first end extending from said valve body to outside and defining an extending end;
a second tank unit having a second tank cavity arranged for receiving the cleaning solution;
a water inlet tube connected between said second tank unit and said valve inlet of said valve body; and
a spray conduit connected between said nozzle member and said valve outlet of said valve body,
wherein when said extending end of said valve core pushrod is pressed, the valve core is driven to withstand an action of said resilient member and to move along said valve body such that high pressure is generated inside said valve body, then the cleaning solution being drawn into said valve body is guided to pass through said valve outlet of said valve body and said spray conduit to spray outside from said nozzle member; wherein when said extending end of said valve core pushrod is released, said valve core returns to its normal position through the action of said resilient member such that negative pressure is formed inside said valve body, then the cleaning solution in said second tank unit is drawn into said valve body through said water inlet tube.

12. The surface cleaning apparatus with mist spray or water spray arrangement according to claim 11, characterized in that, said apparatus further comprises:
a main body defining a top portion; and a connecting member provided at said top portion of said main body having an indented connecting cavity in the middle portion of said connecting member;
wherein said suction mouthpiece is detachably connected to said connecting member; wherein said first tank unit is detachably mounted inside said indented connecting cavity; wherein said nozzle member is positioned between said suction mouthpiece and said first tank unit, and is exposed from said main body; wherein second tank unit is provided inside said main body at a side opposite to the side at which said nozzle member is positioned, and is positioned on top of said first tank unit; wherein said main body further comprises an index window at a position corresponding to said second tank unit and a portion of side wall of said second tank unit is exposed through said index window for viewing a water level of the cleaning solution; wherein said press-type one-way control valve is provided inside said main body and is positioned below said second tank unit; wherein said extending end of said valve core pushrod is extended outside from said main body; wherein said suction unit is provided inside said main body and is positioned below said indented connecting cavity; wherein said main body has a gas outlet open at a position corresponding to a position of a side wall of said suction unit and the environmental air which is drawn into said main body is exhausted from said suction unit through said gas outlet.

13. The surface cleaning apparatus with mist spray or water spray arrangement according to claim 12, characterized in that, said main body comprises: a handle at one side opposite to the side of said indented connecting cavity; and a plug portion at a bottom of said main body at the same side at which said handle is positioned adapted for inserting an elongated extension handle member, wherein said extending end of said valve core pushrod is positioned at the same side at which said handle is positioned.

14. The surface cleaning apparatus with mist spray or water spray arrangement according to claim 4, characterized in that, said bottom portion of said first tank unit 3 comprises a first slanted bottom member on a right side of said first tank unit, upwardly and inclinedly extended from a left side of said bottom portion of said first tank unit to the right side of said first tank unit; and a second slanted bottom member upwardly and inclinely extended continuously from said first slanted bottom member to said right side of said first tank unit to connected to a side wall of said first slanted bottom member, wherein said exhaust pipe is provided on said second slanted bottom member.

15. The surface cleaning apparatus with mist spray or water spray arrangement according to claim 14, characterized in that, said apparatus comprises:
a nozzle member;
a press-type one-way control valve, which comprises a valve body having a valve inlet and a valve outlet; a valve core provided inside said valve body; a resilient member acting on said valve core inside said valve body for positioning; and a valve core pushrod operatively connected to said valve core defining a first end connecting to said valve core and a second end opposite to said first end extending from said valve body to outside and defining an extending end;
a second tank unit having a second tank cavity arranged for receiving the cleaning solution;
a water inlet tube connected between said second tank unit and said valve inlet of said valve body; and
a spray conduit connected between said nozzle member and said valve outlet of said valve body,
wherein when said extending end of said valve core pushrod is pressed, the valve core is driven to withstand an action of said resilient member and to move along said valve body such that high pressure is generated inside said valve body, then the cleaning solution being drawn into said valve body is guided to pass through said valve outlet of said valve body and said spray conduit to spray outside from said nozzle member; wherein when said extending end of said valve core pushrod is released, said valve core returns to its normal position through the action of said resilient member such that negative pressure is formed inside said valve body, then the cleaning solution in said second tank unit is drawn into said valve body through said water inlet tube.

16. The surface cleaning apparatus with mist spray or water spray arrangement according to claim 15, characterized in that, said apparatus further comprises:
a main body defining a top portion; and a connecting member provided at said top portion of said main body having an indented connecting cavity in the middle portion of said connecting member;
wherein said suction mouthpiece is detachably connected to said connecting member; wherein said first connecting pipe is provided inside said main body and is positioned between said connecting member and said indented connecting cavity; wherein said first tank unit is detachably mounted inside said indented connecting cavity; wherein said nozzle member is positioned between said suction mouthpiece and said first tank unit, and is exposed from said main body; wherein second tank unit is provided inside said main body at a side opposite to the side at which said nozzle member is positioned, and is positioned on top of said first tank unit; wherein said main body further comprises an index window at a position corresponding to said second tank unit and a portion of side wall of said second tank unit is exposed through said index window for viewing a water level of the cleaning solution; wherein said press-type one-way control valve is provided inside said main body and is positioned below said second tank unit; wherein said extending end of said valve core pushrod is extended outside from said main body; wherein said second connecting pipe and said suction unit are provided inside said main body and are sequentially positioned below said indented connecting cavity; wherein said main body has a gas outlet open at a position corresponding to a position of a side wall of said suction unit and the environmental air which is drawn into said main body is exhausted from said suction unit through said gas outlet.

17. The surface cleaning apparatus with mist spray or water spray arrangement according to claim 16, characterized in that, said main body comprises: a handle at one side opposite to the side of said indented connecting cavity; and a plug portion at a bottom of said main body at the same side at which said handle is positioned adapted for inserting an elongated extension handle member, wherein said extending end of said valve core pushrod is positioned at the same side at which said handle is positioned.

18. The surface cleaning apparatus with mist spray or water spray arrangement according to claim 5, characterized in that, said bottom portion of said first tank unit 3 comprises a first slanted bottom member on a right side of said first tank unit, upwardly and inclinedly extended from a left side of said bottom portion of said first tank unit to the right side of said first tank unit; and a second slanted bottom member upwardly and inclinely extended continuously from said first slanted bottom member to said right side of said first tank unit to connected to a side wall of said first slanted bottom member, wherein said exhaust pipe is provided on said second slanted bottom member.

19. The surface cleaning apparatus with mist spray or water spray arrangement according to claim 18, characterized in that, said apparatus comprises:
a nozzle member;
a press-type one-way control valve, which comprises a valve body having a valve inlet and a valve outlet; a valve core provided inside said valve body; a resilient member acting on said valve core inside said valve body for positioning; and a valve core pushrod operatively connected to said valve core defining a first end connecting to said valve core and a second end opposite to said first end extending from said valve body to outside and defining an extending end;
a second tank unit having a second tank cavity arranged for receiving the cleaning solution;
a water inlet tube connected between said second tank unit and said valve inlet of said valve body; and
a spray conduit connected between said nozzle member and said valve outlet of said valve body,
wherein when said extending end of said valve core pushrod is pressed, the valve core is driven to withstand an action of said resilient member and to move along said valve body such that high pressure is generated inside said valve body, then the cleaning solution being drawn into said valve body is guided to pass through said valve outlet of said valve body and said spray conduit to spray outside from said nozzle member; wherein when said extending end of said valve core pushrod is released, said valve core returns to its normal position through the action of said resilient member such that negative pressure is formed inside said valve body, then the cleaning solution in said second tank unit is drawn into said valve body through said water inlet tube.

20. The surface cleaning apparatus with mist spray or water spray arrangement according to claim 19, characterized in that, said apparatus further comprises:
a main body defining a top portion; and a connecting member provided at said top portion of said main body having an indented connecting cavity in the middle portion of said connecting member;
wherein said suction mouthpiece is detachably connected to said connecting member; wherein said first connecting pipe is provided inside said main body and is positioned between said connecting member and said indented connecting cavity; wherein said first tank unit is detachably mounted inside said indented connecting cavity; wherein said nozzle member is positioned between said suction mouthpiece and said first tank unit, and is exposed from said main body; wherein second tank unit is provided inside said main body at a side opposite to the side at which said nozzle member is positioned, and is positioned on top of said first tank unit; wherein said main body further comprises an index window at a position corresponding to said second tank unit and a portion of side wall of said second tank unit is exposed through said index window for viewing a water level of the cleaning solution; wherein said press-type one-way control valve is provided inside said main body and is positioned below said second tank unit; wherein said extending end of said valve core pushrod is extended outside from said main body; wherein said second connecting pipe and said suction unit are provided inside said main body and are sequentially positioned below said indented connecting cavity; wherein said main body has a gas outlet open at a position corresponding to a position of a side wall of said suction unit and the environmental air which is drawn into said main body is exhausted from said suction unit through said gas outlet.

21. The surface cleaning apparatus with mist spray or water spray arrangement according to claim 20, characterized in that, said main body comprises: a handle at one side opposite to the side of said indented connecting cavity; and a plug portion at a bottom of said main body at the same side at which said handle is positioned adapted for inserting an elongated extension handle member, wherein said extending end of said valve core pushrod is positioned at the same side at which said handle is positioned.

22. The surface cleaning apparatus with mist spray or water spray arrangement according to claim 6, characterized in that, said bottom portion of said first tank unit 3 comprises a first slanted bottom member on a right side of said first tank unit, upwardly and inclinedly extended from a left side of said bottom portion of said first tank unit to the right side of said first tank unit; and a second slanted bottom member upwardly and inclinely extended continuously from said first slanted bottom member to said right side of said first tank unit to connected to a side wall of said first slanted bottom member, wherein said exhaust pipe is provided on said second slanted bottom member.

23. The surface cleaning apparatus with mist spray or water spray arrangement according to claim 22, characterized in that, said apparatus comprises:
a nozzle member;
a press-type one-way control valve, which comprises a valve body having a valve inlet and a valve outlet; a valve core provided inside said valve body; a resilient member acting on said valve core inside said valve body for positioning; and a valve core pushrod operatively connected to said valve core defining a first end connecting to said valve core and a second end opposite to said first end extending from said valve body to outside and defining an extending end;
a second tank unit having a second tank cavity arranged for receiving the cleaning solution;
a water inlet tube connected between said second tank unit and said valve inlet of said valve body; and
a spray conduit connected between said nozzle member and said valve outlet of said valve body,
wherein when said extending end of said valve core pushrod is pressed, the valve core is driven to withstand an action of said resilient member and to move along said valve body such that high pressure is generated inside said valve body, then the cleaning solution being drawn into said valve body is guided to pass through said valve outlet of said valve body and said spray conduit to spray outside from said nozzle member; wherein when said extending end of said valve core pushrod is released, said valve core returns to its normal position through the action of said resilient member such that negative pressure is formed inside said valve body, then the cleaning solution in said second tank unit is drawn into said valve body through said water inlet tube.

24. The surface cleaning apparatus with mist spray or water spray arrangement according to claim 23, characterized in that, said apparatus further comprises:
a main body defining a top portion; and a connecting member provided at said top portion of said main body having an indented connecting cavity in the middle portion of said connecting member;
wherein said suction mouthpiece is detachably connected to said connecting member; wherein said first connecting pipe is provided inside said main body and is positioned between said connecting member and said indented connecting cavity; wherein said first tank unit is detachably mounted inside said indented connecting cavity; wherein said nozzle member is positioned between said suction mouthpiece and said first tank unit, and is exposed from said main body; wherein second tank unit is provided inside said main body at a side opposite to the side at which said nozzle member is positioned, and is positioned on top of said first tank unit; wherein said main body further comprises an index window at a position corresponding to said second tank unit and a portion of side wall of said second tank unit is exposed through said index window for viewing a water level of the cleaning solution; wherein said press-type one-way control valve is provided inside said main body and is positioned below said second tank unit; wherein said extending end of said valve core pushrod is extended outside from said main body; wherein said second connecting pipe and said suction unit are provided inside said main body and are sequentially positioned below said indented connecting cavity; wherein said main body has a gas outlet open at a position corresponding to a position of a side wall of said suction unit and the environmental air which is drawn into said main body is exhausted from said suction unit through said gas outlet.

25. The surface cleaning apparatus with mist spray or water spray arrangement according to claim 24, characterized in that, said main body comprises: a handle at one side opposite to the side of said indented connecting cavity; and a plug portion at a bottom of said main body at the same side at which said handle is positioned adapted for inserting an elongated extension handle member, wherein said extending end of said valve core pushrod is positioned at the same side at which said handle is positioned.

26. The surface cleaning apparatus with mist spray or water spray arrangement according to claim 2, characterized in that, said apparatus comprises:
a nozzle member;
a press-type one-way control valve, which comprises a valve body having a valve inlet and a valve outlet; a valve core provided inside said valve body; a resilient member acting on said valve core inside said valve body for positioning; and a valve core pushrod operatively connected to said valve core defining a first end connecting to said valve core and a second end opposite to said first end extending from said valve body to outside and defining an extending end;
a second tank unit having a second tank cavity arranged for receiving the cleaning solution;
a water inlet tube connected between said second tank unit and said valve inlet of said valve body; and
a spray conduit connected between said nozzle member and said valve outlet of said valve body,
wherein when said extending end of said valve core pushrod is pressed, the valve core is driven to withstand an action of said resilient member and to move along said valve body such that high pressure is generated inside said valve body, then the cleaning solution being drawn into said valve body is guided to pass through said valve outlet of said valve body and said spray conduit to spray outside from said nozzle member; wherein when said extending end of said valve core pushrod is released, said valve core returns to its normal position through the action of said resilient member such that negative pressure is formed inside said valve body, then the cleaning solution in said second tank unit is drawn into said valve body through said water inlet tube.

27. The surface cleaning apparatus with mist spray or water spray arrangement according to claim 26, characterized in that, said apparatus further comprises:
a main body defining a top portion; and a connecting member provided at said top portion of said main body having an indented connecting cavity in the middle portion of said connecting member;
wherein said suction mouthpiece is detachably connected to said connecting member; wherein said first tank unit is detachably mounted inside said indented connecting cavity; wherein said nozzle member is positioned between said suction mouthpiece and said first tank unit, and is exposed from said main body; wherein second tank unit is provided inside said main body at a side opposite to the side at which said nozzle member is positioned, and is positioned on top of said first tank unit; wherein said main body further comprises an index window at a position corresponding to said second tank unit and a portion of side wall of said second tank unit is exposed through said index window for viewing a water level of the cleaning solution; wherein said press-type one-way control valve is provided inside said main body and is positioned below said second tank unit;
wherein said extending end of said valve core pushrod is extended outside from said main body; wherein said suction unit is provided inside said main body and is positioned below said indented connecting cavity; wherein said main body has a gas outlet open at a position corresponding to a position of a side wall of said suction unit and the environmental air which is drawn into said main body is exhausted from said suction unit through said gas outlet.

28. The surface cleaning apparatus with mist spray or water spray arrangement according to claim 27, characterized in that, said main body comprises: a handle at one side opposite to the side of said indented connecting cavity; and a plug portion at a bottom of said main body at the same side at which said handle is positioned adapted for inserting an elongated extension handle member, wherein said extending end of said valve core pushrod is positioned at the same side at which said handle is positioned.
